(19) United States
(12) Patent Application Publication
(10) Pub. No.: US 2025/0297100 A1
(43) Pub. Date: Sep. 25, 2025

(54) UNSATURATED CARBON-CONTAINING THERMOSETTING RESIN AND MANUFACTURING METHOD THEREOF

(71) Applicant: e-Ray Optoelectronics Technology Co., Ltd., Taoyuan City (TW)

(72) Inventor: Kuo-Liang YEH, Taoyuan City (TW)

(21) Appl. No.: 19/084,771

(22) Filed: Mar. 20, 2025

(30) Foreign Application Priority Data
Mar. 21, 2024 (TW) 113110518

(51) Int. Cl. C08L 71/12; C08F 212/08; C08F 212/14; C08G 73/10

(52) U.S. Cl. CPC C08L 71/126; C08F 212/08; C08F 212/18; C08G 73/10; C08L 2203/20

(57) ABSTRACT

An unsaturated carbon-containing thermosetting resin and a manufacturing method of the unsaturated carbon-containing thermosetting resin are provided. The unsaturated carbon-containing thermosetting resin includes a structure represented by formula (1), and symbols in formula (1) are as defined in the specification. The manufacturing method of the unsaturated carbon-containing thermosetting resin includes providing a polymer solution, performing a pre-polymerization reaction by mixing the polymer solution and an alkaline solution, and performing a polymerization reaction by mixing the pre-polymerization solution, a benzene compound solution and a polystyrene compound solution so as to obtain the unsaturated carbon-containing thermosetting resin.

### RELATED APPLICATIONS

This application claims priority to Taiwan Application Serial Number 113110518, filed Mar. 21, 2024, which is herein incorporated by reference.

### BACKGROUND

### Technical Field

The present disclosure relates to a thermosetting resin and a manufacturing method thereof. More particularly, the present disclosure relates to an unsaturated carbon-containing thermosetting resin and a manufacturing method thereof.

### Description of Related Art

Recently, the developments of electronic devices trend to thinness, structural densification and high speed. At present, the industrial technology of printed circuit boards (PCB) in hard boards or in soft boards is developed towards high frequency, high speed and high-density structure. Hence, the demand for materials has become increasingly stringent. Moreover, the need for large-scale data transmission in mobile communications has driven related processes and materials towards the high-frequency range (above 1 GHZ). The key material properties required include low dielectric (Dk), low dissipation factor (Df), high thermal resistance and good mechanical strength. Among these materials, thermosetting resin is widely used in printed circuit boards because of the chemical resistance, the material rigidity, the thermal stability, the insulation and the low dissipation factor thereof, which meet the requirements of material applications in the printed circuit boards.

However, the adhesion of conventional thermosetting resins to the printed circuit boards is poor, and the thermal stability and the mechanical strength of the conventional thermosetting resins need to be improved. Moreover, during the production process of the conventional thermosetting resins, the conventional thermosetting resins often have inconsistent weight-average molecular weights across different production batches, which affect the stability of packaging processes of the printed circuit boards.

In view of this, it is necessary to develop a thermosetting resin with a good rigid structure, a high thermal stability and a stable weight-average molecular weight, and the thermosetting resin can be used in printed circuit boards so as to obtain the printed circuit boards with the high structural strength, and it is favorable for improving the stability of packaging processes of the printed circuit boards.

### SUMMARY

According to one aspect of the present disclosure, an unsaturated carbon-containing thermosetting resin includes a structure represented by formula (1):

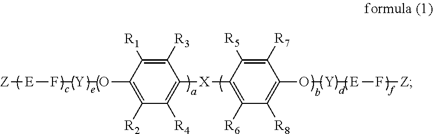

wherein X is —CH₂—, —CH(CH₃)— or —C(CH₃)₂—, R₁, R₂, R₃, R₄, R₅, R₆, R₇ and R₈ are each independently a hydrogen atom or a hydrocarbon group of 1 to 3 carbon atoms, a and b are each independently a real number from 2 to 500, Y is a structure represented by formula (2), and c and d are each independently a real number from 1 to 300,

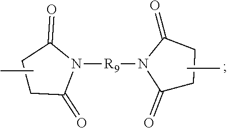

wherein R₉ is a hydrocarbon group of 4 to 20 carbon atoms, E is a structure represented by formula (3), F is a structure represented by formula (4), and e and f are each independently a real number from 1 to 200,

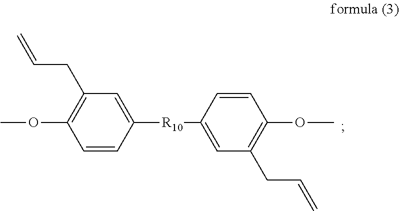

wherein R₁₀ is a linear hydrocarbon group of 2 to 6 carbon atoms, or a branched hydrocarbon group of 2 to 6 carbon atoms,

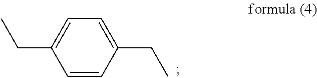

wherein Z is a structure represented by formula (5):

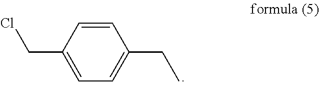

According to another aspect of the present disclosure, a manufacturing method of the unsaturated carbon-containing thermosetting resin of the aforementioned aspect includes the steps as follows. A polymer solution is provided, and the polymer solution includes a polyphenyleneoxide compound, a phenol compound, a maleimide compound and a first solvent. A pre-polymerization reaction is performed by mixing the polymer solution and an alkaline solution at a pre-polymerization temperature for a pre-polymerization time to form a pre-polymerization solution. A polymerization reaction is performed by mixing the pre-polymerization solution, a benzene compound solution and a polystyrene compound solution at a polymerization temperature for a polymerization time to form a polymerization solution, and the polymerization solution includes the unsaturated carbon-containing thermosetting resin.

### BRIEF DESCRIPTION OF THE DRAWINGS

The present disclosure can be more fully understood by reading the following detailed description of the embodiment, with reference made to the accompanying drawings as follows:

FIG. 1 is a flow chart of a manufacturing method of the unsaturated carbon-containing thermosetting resin according to one embodiment of the present disclosure.

FIG. 2 is an infrared spectrum of Example 4, Comparative example 1, BMI-H and SA 90.

### DETAILED DESCRIPTION

The present disclosure will be further exemplified by the following specific embodiments. However, the embodiments can be applied to various inventive concepts and can be embodied in various specific ranges. The specific embodiments are only for the purposes of description, and are not limited to these practical details thereof. In addition, some conventional structures and elements are illustrated in the drawings in a simple and schematic way, and repeated elements can be presented by the same reference numerals.

### <Unsaturated Carbon-Containing Thermosetting Resin>

An unsaturated carbon-containing thermosetting resin of the present disclosure includes a structure represented by formula (1):

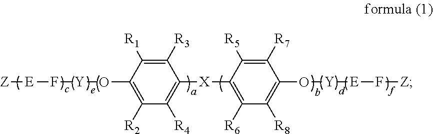

wherein X is —CH₂—, —CH(CH₃)— or —C(CH₃)₂—, R₁, R₂, R₃, R₄, R₅, R₆, R₇ and R₈ are each independently a hydrogen atom or a hydrocarbon group of 1 to 3 carbon atoms, a and b are each independently a real number from 2 to 500, Y is a structure represented by formula (2), and c and d are each independently a real number from 1 to 300,

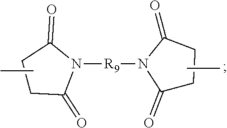

wherein R₉ is a hydrocarbon group of 4 to 20 carbon atoms, E is a structure represented by formula (3), F is a structure represented by formula (4), and e and f are each independently a real number from 1 to 200,

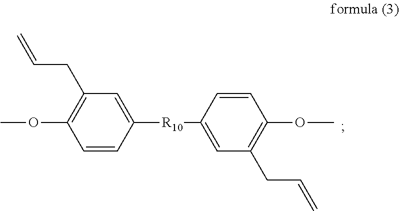

wherein R₁₀ is a linear hydrocarbon group of 2 to 6 carbon atoms, or a branched hydrocarbon group of 2 to 6 carbon atoms,

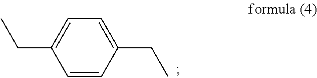

wherein Z is a structure represented by formula (5):

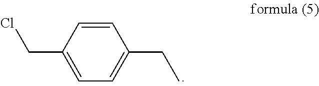

Preferably, Y can be a structure represented by formula (6):

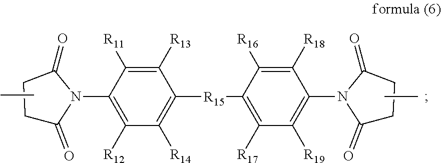

wherein R₁₅ is a hydrocarbon group of 1 to 3 carbon atoms, R₁₁, R₁₂, R₁₈ and R₁₉ are each independently a hydrocarbon group of 1 to 5 carbon atoms, R₁₃, R₁₄, R₁₆ and R₁₇ are each independently a hydrogen atom or a hydrocarbon group of 1 to 3 carbon atoms. Therefore, the unsaturated carbon-containing thermosetting resin of the present disclosure includes a molecular segment with a rigid structure for the excellent mechanical strength.

Preferably, Y can be a structure represented by formula (7):

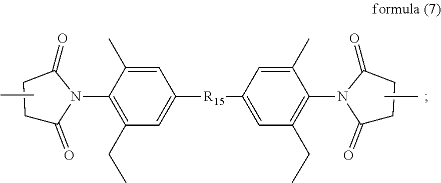

therefore, the unsaturated carbon-containing thermosetting resin of the present disclosure includes a molecular segment with a rigid and planar structure for the excellent mechanical strength. Moreover, the good molecular symmetry of the unsaturated carbon-containing thermosetting resin results in a low polarity, and it is favorable for the application in a high-frequency printed circuit board with a low dissipation factor (Df).

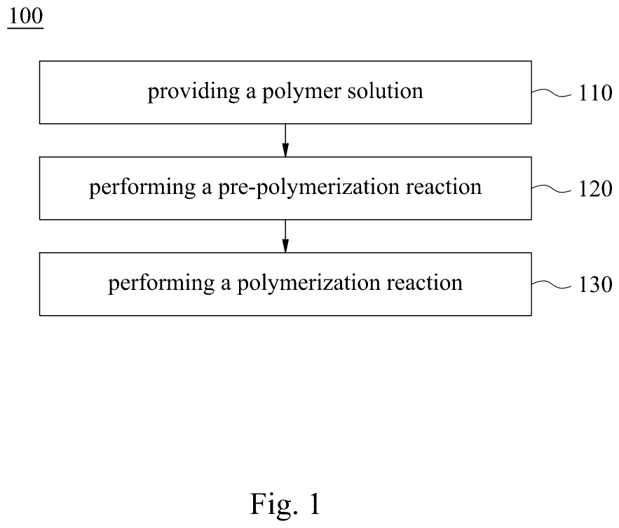

Reference is made to FIG. 1, which is a flow chart of a manufacturing method of the unsaturated carbon-containing thermosetting resin 100 according to one embodiment of the present disclosure. The manufacturing method of the unsaturated carbon-containing thermosetting resin 100 includes step 110, step 120 and step 130.

In step 110, a polymer solution is provided, and the polymer solution includes a polyphenyleneoxide compound, a phenol compound, a maleimide compound and a first solvent. The first solvent can be dimethylacetamide (DMAc). The phenol compound can be a bisphenol A derivative. Specifically, the bisphenol A derivative is a compound derived from a bisphenol A. For example, the bisphenol A derivative can be 2,2′-diallylbisphenol A.

In step 120, a pre-polymerization reaction is performed, in which the polymer solution and an alkaline solution are mixed at a pre-polymerization temperature for a pre-polymerization time to perform the pre-polymerization reaction so as to form a pre-polymerization solution. Moreover, the pre-polymerization temperature can be 35° C. to 65° C., a pH value can be 7.5 to 10.5, and the pre-polymerization time can be 3 hours to 7 hours so as to obtain a pre-polymerization solution. The alkaline solution can be a potassium hydroxide (KOH) solution.

In step 130, a polymerization reaction is performed, in which the pre-polymerization solution, a benzene compound solution and a polystyrene compound solution are mixed at a polymerization temperature for a polymerization time to perform the polymerization reaction so as to form a polymerization solution, and the polymerization solution includes the unsaturated carbon-containing thermosetting resin. Moreover, the polymerization temperature can be 35° C. to 65° C., and the polymerization time can be 12 hours to 18 hours. Furthermore, the benzene compound solution includes a benzene compound, and the benzene compound can be selected from the group consisting of 1,3-bis(trichloromethyl)benzene, 1,4-bis(trichloromethyl)benzene, 1,4-bis(chloromethyl)benzene, 2,4-bis(chloromethyl)-1,3,5-trimethylbenzene and 4,4′-bis(chloromethyl) biphenyl. Further, the polystyrene compound solution includes a polystyrene compound, and the polystyrene compound can be 2-(chloromethyl) styrene, 3-(chloromethyl) styrene or 4-(chloromethyl) styrene.

The following specific embodiments further illustrate the present disclosure for those with ordinary skill in the technical field to utilize and realize the present disclosure without excessive interpretation. These embodiments should not limit the scope of the present disclosure, but illustrate how to implement the materials and methods of the present disclosure.

### Example 1

90±5 kg of the polyphenyleneoxide compound and 3.2±0.3 kg of the bisphenol A derivative were dissolved in 280±20 kg of dimethylacetamide and placed in a reaction kettle, wherein the polyphenyleneoxide compound is NORYL™ SA90 (patented structure of Sabic, hereinafter referred to as SA90). A feed pipe, a stirring blade, a thermometer and a pH meter were equipped on the reaction kettle, and a heating mantle was disposed outside the reaction kettle to adjust the temperature in the reaction kettle. The stirring blade could be turned on to continuously stir the liquid in the reaction kettle for 0.5 hour to 1.5 hours so that the liquid in the reaction kettle could be homogenized. Then, 5±1.5 kg of the maleimide compound was added through the feed pipe into the reaction kettle, and the liquid in the reaction kettle was continuously stirred for 1 hour to 2.5 hours to form a polymer solution. The maleimide compound is bismaleimide-H (hereinafter referred to as BMI-H).

7.4±1.5 kg of the potassium hydroxide solution was added through the feed pipe into the reaction kettle, the temperature in the reaction kettle was 35° C. to 65° C., the pH value was 7.5 to 10.5, and the liquid in the reaction kettle could be be continuously stirred for 3 hours to 7 hour to perform a pre-polymerization reaction so that a pre-polymerization solution was formed.

2.4±0.15 kg of the benzene compound solution and 1.65±1.5 kg of the polystyrene compound solution were added through the feed pipe into the reaction kettle, the temperature in the reaction kettle was 35° C. to 65° C., and the liquid in the reaction kettle could be continuously stirred for 12 hours to 18 hours to perform a polymerization reaction so that a polymerization solution including the unsaturated carbon-containing thermosetting resin of Example 1 was formed. The unsaturated carbon-containing thermosetting resin of Example 1 (hereinafter referred to as Example 1) includes a structure represented by formula (1):

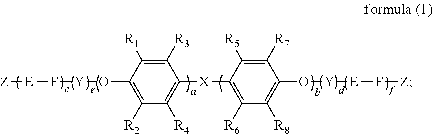

wherein X is —C(CH₃)₂—, R₁, R₂, R₇ and R₈ are each independently —CH₃, R₃, R₄, R₅, and R₆ are each independently a hydrogen atom, a and b are each independently a real number from 2 to 35, Y is a structure represented by formula (7), and c and d are each independently a real number from 1 to 4,

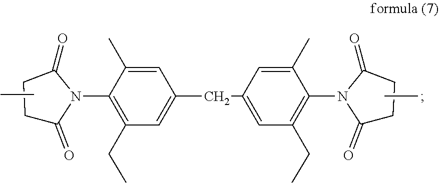

wherein E is a structure represented by formula (3), F is a structure represented by formula (4), and e and f are each independently a real number from 1 to 6,

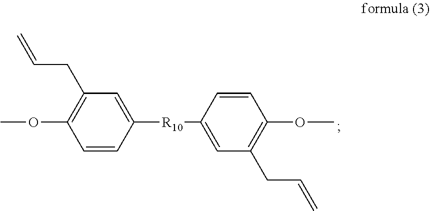

wherein R₁₀ is —C(CH₃)₂—,

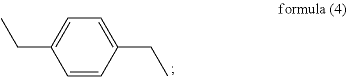

wherein Z is a structure represented by formula (5),

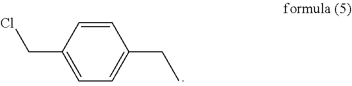

### Example 2

A manufacturing method of an unsaturated carbon-containing thermosetting resin of Example 2 (hereinafter referred to as Example 2) is similar to the manufacturing method of Example 1, the structure of Example 2 is similar to the structure of Example 1, and the difference is that 11±1.5 kg of BMI-H was added through the feed pipe into the reaction kettle in the manufacturing method of Example 2, and the other manufacturing conditions of Example 2 are same as Example 1.

### Example 3

A manufacturing method of an unsaturated carbon-containing thermosetting resin of Example 3 (hereinafter referred to as Example 3) is similar to the manufacturing method of Example 1, the structure of Example 3 is similar to the structure of Example 1, and the difference is that 17±1.5 kg of BMI-H was added through the feed pipe into the reaction kettle in the manufacturing method of Example 3, and the other manufacturing conditions of Example 3 are same as Example 1.

### Example 4

A manufacturing method of an unsaturated carbon-containing thermosetting resin of Example 4 (hereinafter referred to as Example 4) is similar to the manufacturing method of Example 1, the structure of Example 4 is similar to the structure of Example 1, and the difference is that 23±1.5 kg of BMI-H was added through the feed pipe into the reaction kettle in the manufacturing method of Example 4, and the other manufacturing conditions of Example 4 are same as Example 1.

### Example 5

A manufacturing method of an unsaturated carbon-containing thermosetting resin of Example 5 (hereinafter referred to as Example 5) is similar to the manufacturing method of Example 1, the structure of Example 5 is similar to the structure of Example 1, the difference is that 29±1.5 kg BMI-H was added through the feed pipe into the reaction kettle in the manufacturing method of Example 5, and the other manufacturing conditions of Example 5 are same as Example 1.

### Comparative Example 1

A manufacturing method of an unsaturated carbon-containing thermosetting resin of Comparative example 1 (hereinafter referred to as Comparative example 1) is similar to the manufacturing method of Example 1, and the difference is that BMI-H was not added into the reaction kettle in the manufacturing method of Comparative example 1. Comparative example 1 includes a structure represented by formula (8):

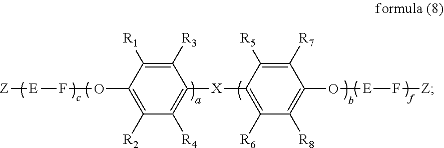

wherein X is —C(CH₃)₂—, R₁, R₂, R₇ and R₈ are each independently —CH₃, R₃, R₄, R₅, and R₆ are each independently a hydrogen atom, a and b are each independently a real number from 2 to 35, E is a structure represented by formula (3), F is a structure represented by formula (4), and e and f are each independently a real number from 1 to 6,

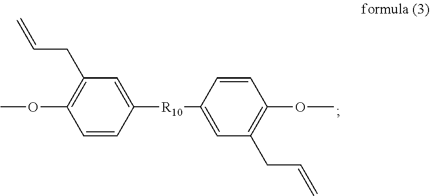

wherein R₁₀ is —C(CH₃)₂—,

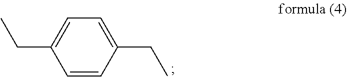

wherein Z is a structure represented by formula (5),

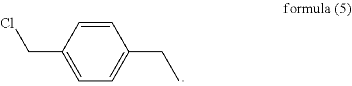

### <Infrared Spectrum (IR)>

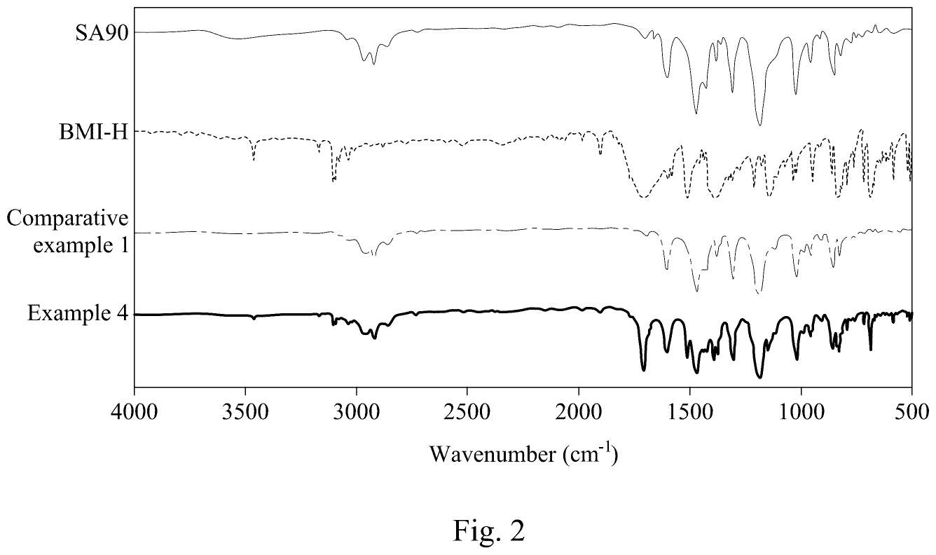

Reference is made to FIG. 2, which is an infrared spectrum of Example 4, Comparative example 1, BMI-H and SA 90. Example 4 is the unsaturated carbon-containing thermosetting resin with a maleimide structure, Comparative example 1 is the unsaturated carbon-containing thermosetting resin without the maleimide structure. Comparing with Comparative example 1, in the infrared spectrum of Example 4, a characteristic peak of C═O of the maleimide structure is at 1710 cm⁻¹. The characteristic peak at 1710 cm⁻¹ in the infrared spectrum of Example 4 is same as in the infrared spectrum of BMI-H so that the unsaturated carbon-containing thermosetting resin of the present disclosure includes a graft maleimide structure on the polymer chain of SA90.

### <Gel Permeation Chromatography (GPC)>

Weight-average molecular weights (Mw) of Example 1 to Example 5 and Comparative example 1 were analyzed via gel permeation chromatography, and listed in Table 1. Specifically, Example 1 to Example 5 are the unsaturated carbon-containing thermosetting resins with the maleimide structure, and Comparative example 1 is the unsaturated carbon-containing thermosetting resin without the maleimide structure. In Table 1, comparing with Comparative Example 1, the unsaturated carbon-containing thermosetting resins of Example 1 to Example 5 respectively including the graft maleimide structure on the polymer chain of SA90 so that the weight-average molecular weights of Example 1 to Example 5 are respectively higher than Comparative Example 1. Moreover, the graft maleimide structure on the polymer chain of SA90 can provide the rigid structure to improve the mechanical property.

TABLE 1

| | Mw | | Mw |
|---|---|---|---|
| | (g/mol) | | (g/mol) |
| Example 1 | 5779 | Example 4 | 6319 |
| Example 2 | 5862 | Example 5 | 6278 |
| Example 3 | 5887 | Comparative | 5682 |
| | | example 1 | |

### <Thermal Property Evaluation>

The thermal property evaluation of Example 1 to Example 5 and Comparative example 1 were performed via differential scanning calorimeter (DSC) to measure the glass transition temperature (Tg) and the measurement results are listed in Table 2. Specifically, the heating conditions in DSC are as outlined below. In the first heating, the sample was heated from 50° C. to 350° C. with a heating rate of 20° C./min, cooled from 350° C. to 50° C. with a cooling rate of 80° C./min, and maintained at 50° C. for 2 minutes. In the second heating, the sample was heated from 50° C. to 350° C. with the heating rate of 20° C./min.

Reference is made to Table 2, which shows the results of the glass transition temperature. In Table 2, comparing with Comparative Example 1, the results of the glass transition temperature of Example 1 to Example 5 are respectively higher than Comparative Example 1, because the graft maleimide structure on the polymer chain is planar so that the polymer chains are easily to be arranged and the glass transition temperature of the unsaturated carbon-containing thermosetting resin can be improved. Accordingly, the thermal stability of the unsaturated carbon-containing thermosetting resin of the present disclosure is better.

TABLE 2

| | glass transition | | glass transition |
|---|---|---|---|
| | temperature Tg (° C.) | | temperature Tg (° C.) |
| Example 1 | 152.9 | Example 4 | 156.7 |
| Example 2 | 153.6 | Example 5 | 157.3 |
| Example 3 | 154.5 | Comparative | 147.9 |
| | | Example 1 | |

### <Preparation of Glue Formula>

The glue formulas according to Example 1 to Example 5 and Comparative example 1 were prepared for evaluating the thermal stability of the unsaturated carbon-containing thermosetting resins applied to the gluing process of printed circuit boards. The steps of the preparation of the glue formula are as outlined below. 110±5 g of methyl ethyl ketone (MEK) was respectively added to 100±2 g of Example 1 to Example 5 and Comparative example 1, then 67±1 g triallyl isocyanurate (TAIC) was respectively added as a crosslinking agent, and the mixture was stirred at room temperature until the solid was completely dissolved. In which, 10±0.5 g of the 10 wt % initiator was respectively added so that the glue formulas according to Example 1 to Example 5 and Comparative example 1 were obtained. The initiator included dicumyl peroxide (DCP) and MEK. The gluing process of the glue formula according to Example 1 was performed at 170±1.5° C. to obtain a cured product of Example 6 (hereinafter referred to as Example 6). Example 2 was used to replace Example 1, and a cured product of Example 7 (hereinafter referred to as Example 7) was obtained in a gluing process similar to Example 6. Example 3 was used to replace Example 1, and a cured product of Example 8 (hereinafter referred to as Example 8) was obtained in a gluing process similar to Example 6. Example 4 was used to replace Example 1, and a cured product of Example 9 (hereinafter referred to as Example 9) was obtained in a gluing process similar to Example 6. Example 5 was used to replace Example 1, and a cured product of Example 10 (hereinafter referred to as Example 10) was obtained in a gluing process similar to Example 6. Comparative example 1 was used to replace Example 1, and a cured product of Comparative example 2 (hereinafter referred to as Comparative example 2) was obtained in a gluing process similar to Example 6.

### <Thermal Property Evaluation of Cured Product>

The thermal property evaluation of Example 6 to Example 10 and Comparative example 2 was performed via DSC to measure the glass transition temperature, and the measurement results are listed in Table 3. Specifically, the heating conditions in DSC are as outlined below. In the first heating, the sample was heated from 50° C. to 350° C. with a heating rate of 20° C./min, cooled from 350° C. to 50° C. with a cooling rate of 80° C./min, and maintained at 50° C. for 2 minutes. In the second heating, the sample was heated from 50° C. to 350° C. with the heating rate of 20° C./min.

Reference is made to Table 3, which show the results of the glass transition temperature of Example 6 to Example 10 and Comparative example 2. In Table 3, comparing with Comparative Example 2, Example 6 to Example 10 have higher glass transition temperatures and better thermal stability. Therefore, applying the unsaturated carbon-containing thermosetting resin of the present disclosure to the printed circuit board process is favorable for improving the production stability of the printed circuit board process.

TABLE 3

| cured | glass transition |
|---|---|
| product | temperature Tg (° C.) |
| Example 6 | 189.0 |
| Example 7 | 190.8 |
| Example 8 | 193.9 |
| Example 9 | 195.7 |
| Example 10 | 199.3 |
| Comparative | 186.4 |
| Example 2 | |

In conclusion, the unsaturated carbon-containing thermosetting resin of the present disclosure is easily synthesized and conveniently mass-produced. Moreover, the unsaturated carbon-containing thermosetting resin of the present disclosure includes a good rigid structure with a high glass transition temperature so that applying the unsaturated carbon-containing thermosetting resin of the present disclosure to printed circuit boards is favorable to obtain the printed circuit boards with excellent mechanical strength and excellent thermal stability.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An unsaturated carbon-containing thermosetting resin, comprising a structure represented by formula (1): 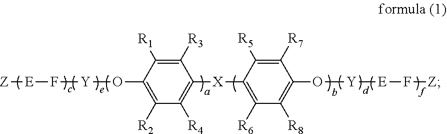
wherein X is —CH₂—, —CH(CH₃)— or —C(CH₃)₂—;
wherein R₁, R₂, R₃, R₄, R₅, R₆, R₇ and R₈ are each independently a hydrogen atom or a hydrocarbon group of 1 to 3 carbon atoms, a and b are each independently a real number from 2 to 500;
wherein Y is a structure represented by formula (2), and c and d are each independently a real number from 1 to 300: 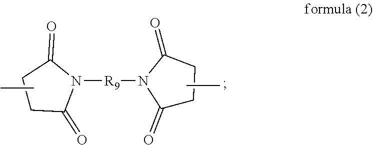
wherein R₉ is a hydrocarbon group of 4 to 20 carbon atoms;
wherein E is a structure represented by formula (3), F is a structure represented by formula (4), and e and f are each independently a real number from 1 to 200: 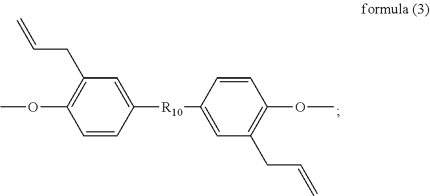
wherein R₁₀ is a linear hydrocarbon group of 2 to 6 carbon atoms, or a branched hydrocarbon group of 2 to 6 carbon atoms; 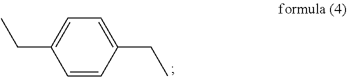
wherein Z is a structure represented by formula (5):

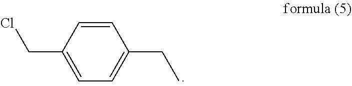

2. The unsaturated carbon-containing thermosetting resin of claim 1, wherein Y is a structure represented by formula (6): 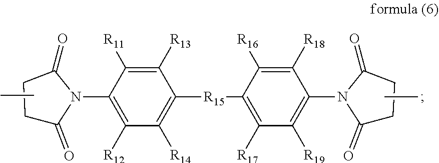
wherein R₁₅ is a hydrocarbon group of 1 to 3 carbon atoms, R₁₁, R₁₂, R₁₈ and R₁₉ are each independently a hydrocarbon group of 1 to 5 carbon atoms, R₁₃, R₁₄, R₁₆ and R₁₇ are each independently a hydrogen atom or a hydrocarbon group of 1 to 3 carbon atoms.

3. The unsaturated carbon-containing thermosetting resin of claim 1, wherein Y is a structure represented by formula (7):

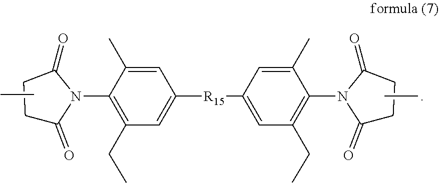

4. A manufacturing method of the unsaturated carbon-containing thermosetting resin of claim 1, comprising:
providing a polymer solution comprising a polyphenyleneoxide compound, a phenol compound, a maleimide compound and a first solvent;
performing a pre-polymerization reaction by mixing the polymer solution and an alkaline solution at a pre-polymerization temperature for a pre-polymerization time to form a pre-polymerization solution; and
performing a polymerization reaction by mixing the pre-polymerization solution, a benzene compound solution and a polystyrene compound solution at a polymerization temperature for a polymerization time to form a polymerization solution, wherein the polymerization solution comprises the unsaturated carbon-containing thermosetting resin.

5. The manufacturing method of the unsaturated carbon-containing thermosetting resin of claim 4, wherein the phenol compound is a bisphenol A derivative.

6. The manufacturing method of the unsaturated carbon-containing thermosetting resin of claim 4, wherein the pre-polymerization temperature is 35° C. to 65° C., and the pre-polymerization time is 3 hours to 7 hours.

7. The manufacturing method of the unsaturated carbon-containing thermosetting resin of claim 4, wherein the pre-polymerization reaction is performed in an environment with a pH value of 7.5 to 10.5.

8. The manufacturing method of the unsaturated carbon-containing thermosetting resin of claim 4, wherein the benzene compound solution comprises a benzene compound, and the benzene compound is selected from the group consisting of 1,3-bis(trichloromethyl)benzene, 1,4-bis(trichloromethyl)benzene, 1,4-bis(chloromethyl)benzene, 2,4-bis(chloromethyl)-1,3,5-trimethylbenzene and 4,4′-bis(chloromethyl) biphenyl.

9. The manufacturing method of the unsaturated carbon-containing thermosetting resin of claim 4, wherein the polystyrene compound solution comprises a polystyrene compound, and the polystyrene compound is 2-(chloromethyl) styrene, 3-(chloromethyl) styrene or 4-(chloromethyl) styrene.

10. The manufacturing method of the unsaturated carbon-containing thermosetting resin of claim 4, wherein the polymerization temperature is 35° C. to 65° C., and the polymerization time is 12 hours to 18 hours.
